(19) United States
(12) Patent Application Publication
(10) Pub. No.: US 2003/0006007 A1
(43) Pub. Date: Jan. 9, 2003

(54) Method of laminating copper foil onto a printed circuit board

(76) Inventors: Chia-Pin Lin, Sanchung (TW); Chih-Peng Fan, Taipei Hsien (TW); Chang-Yun Hung, Yangmei (TW); Sheng-Chou Lee, Taipei (TW)

Correspondence Address: J.C. PATENTS INC., Suite 250, 4 Venture, Irvine, CA, 92618, US

(21) Appl. No.: 09/901,500

(22) Filed: Jul. 3, 2001

(51) Int. Cl. B32B 31/20

(52) U.S. Cl. 156/308.2

(57) ABSTRACT

A method of laminating copper foil onto a substrate of a printed circuit board, wherein the substrate has an upper surface and a lower surface. Isolating material is coated onto both surfaces of the substrate to form isolating layers on the substrate. The isolating layers can be formed by roll coating, spray coating or screen printing. The thickness of the isolating layers can be controlled in accordance to the requirements of the circuits. Various types of metal foils can be laminated onto the adhesive layers, followed by heating and pressurization processes to secure the metal foil onto the substrate.

### BACKGROUND OF THE INVENTION

1. Field of Invention

The present invention relates to a printed circuit board. More particularly, the present invention relates to a method of laminating metal foil onto a printed circuit board.

2. Description of the Related Art

The increasing complexity of electronic products requires an increase in density of printed circuit boards (PCB) that can be fabricated in two different ways. The PCB can be fabricated by a laminated method or a build-up method. A multi-layer circuit board is an example of a high-density printed circuit board, wherein a plurality of patterned trace layers are laminated together whereby the circuits of the respective patterned trace layers are connected to each other. A laminated type printed circuit board, such as a multi-layer circuit, comprises pre-pregs provided therebetween and thereafter being secured to each other.

FIGS. 1a and 1b illustrate schematic views of two types of coated copper foil. FIG. 1a shows one layer of copper foil 101 that is coated with an isolating layer 100, such as pre-preg. FIG. 1b, however, shows a layer of isolating material 100, such as pre-preg, that is laminated between two layers of copper foil 101 and 102. These coated copper foils 101 and 102 are usually used as a core or a raw material for the PCB to undergo further circuit configuration. Due to the high complexity of the PCB designs, different sizes and various types of raw materials are required to meet the demands. Unfortunately, the conventional coated copper foils 101 and 102 are limited to particular sizes due to the fact that the thickness of the isolating layer 100 is restricted to the type of copper foil used.

However, the thickness of the isolating layer of the PCB can affect the Radio frequency (RF) properties and the impedance of the circuit. Therefore the thickness of the PCB is controlled according to the requirements of the circuit properties. Since the conventional method of fabricating the coated copper foil is limited to certain sizes, the RF properties and the impedance of the PCB cannot be controlled easily. Another disadvantage of the conventional method is an alignment problem during the lamination process.

### SUMMARY OF THE INVENTION

The present invention is intended to overcome the above-described disadvantages of the conventional techniques.

It is an object of the present invention to provide a method for laminating a metal foil onto a printed circuit board, in which an isolating layer is formed by a rolling method.

It is another object of the present invention to provide a method of adhering a metal foil onto a printed circuit board, in which an isolating layer is formed by a spraying method.

It is further another object of the present invention to provide a method of adhering a metal foil onto a printed circuit board, in which an isolating layer is formed by a screen printing method.

In achieving the above objects, the present invention provides a method of fabricating a substrate of a printed circuit board in which the steps of the method comprise: providing a substrate having an upper and lower surface; coating isolating material onto the upper and lower surfaces of the substrate; performing a curing process to allow the isolating material to form isolating layers on the upper and lower surfaces of the substrate; and laminating metal foils onto the isolating layers formed on the upper and lower surfaces of the substrate.

Both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIGS. 1a and 1b are schematic cross-sectional views of coated copper foil.

FIG. 2 is a schematic view of coating isolating material onto a substrate by rolling in accordance with a first embodiment of the present invention.

FIG. 3 is a schematic view of coating isolating material onto a substrate by spraying in accordance with a second embodiment of the present invention.

FIG. 4 is a schematic view of coating isolating material onto a substrate by screen printing in accordance with a third embodiment of the present invention.

FIG. 5 is a schematic cross-sectional view of laminating metal foils onto a substrate that is coated with isolating material.

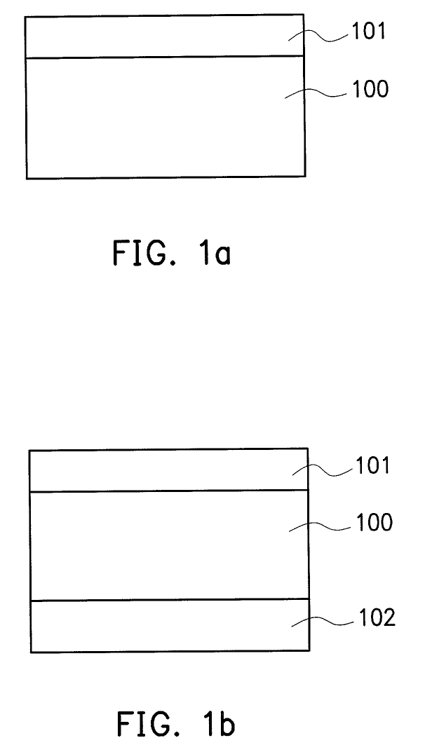

### DESCRIPTION OF THE PREFERRED EMBODIMENTS

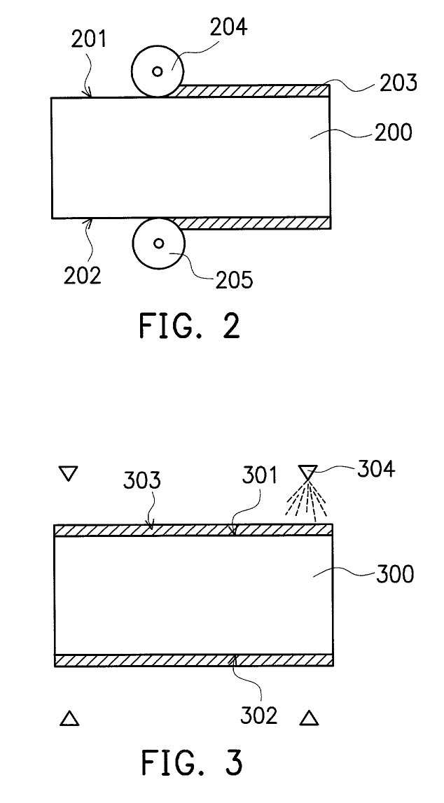

The present invention provides a method of laminating copper foil onto a printed circuit board. Various types of coating methods will be described in the following embodiments. Referring to FIG. 2, an isolating material is applied onto a substrate by a rolling method in accordance with a first preferred embodiment of the present invention. A substrate 200, has an upper surface 201 and a lower surface 202. A circuit (not shown) can be formed on the surface of the substrate. The substrate 200 is made of materials such as flame-retardant epoxy-glass fabric composite resin (FR-4, FR-5) or bismaleimide-triazine (BT). An isolating layer 203 can be formed by a method in which an isolating material 203 is directly coated on the substrate by a suitable coating means, such as roll coating. The isolating material 203 is either coated on the upper surface 201 or the lower surface 202 or on both upper and lower surfaces of the substrate. The isolating material 203 comprises liquid epoxy resin, polymer, polyimide or the like. The rolling process uses at least two rollers 204 and 205. The isolating material 203 is first coated onto the outer circumference of the rollers, and then laminated onto the surfaces of the substrate by the rollers 204 and 205. The rollers 204 and 205 can be rolled backward and forward to ensure that the isolating material 203 is evenly coated onto both surfaces of the substrate. A curing process is performed once the isolating material 203 is coated onto the surfaces of the substrate to allow the isolating material 203 to cure.

FIG. 3 illustrates an isolating material that is applied onto a substrate by a spraying method in accordance with a second preferred embodiment of the present invention. The substrate 300 has an upper surface 301 and a lower surface 302. An isolating material 303 is either coated on the upper surface 301 or the lower surface 302 or on both upper and lower surfaces of the substrate. The spraying system comprises a plurality of spraying nozzles 304. The isolating material 301, such as liquid epoxy, is supplied by the nozzles 304 that spray the liquid epoxy on the surfaces of the substrate. The nozzles 304 are designed in such a way that the isolating material 301 is supplied evenly and precisely on the surfaces of the substrate. The output and the spraying pattern are automatically controlled and are precise to coat the isolating layers evenly and uniformly on both surfaces of the substrate. A curing process is performed once the isolating material 303 is coated onto the surfaces of the substrate to cure the isolating material 303.

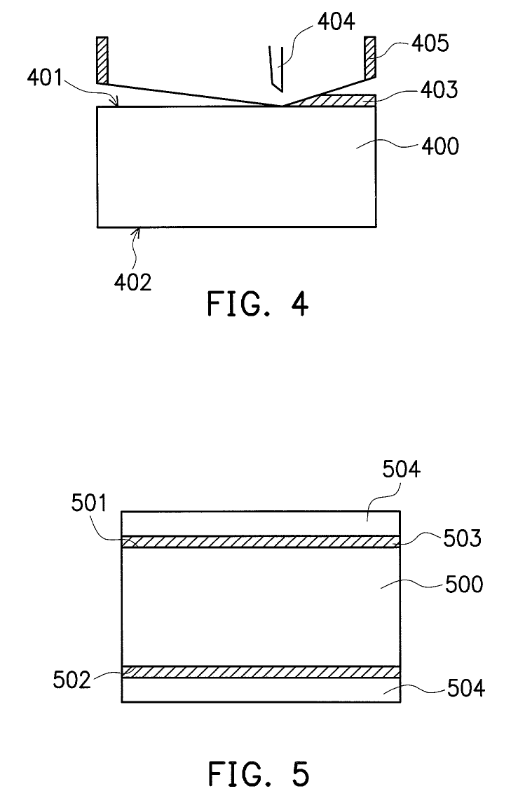

FIG. 4 illustrates an isolating material that is coated onto a substrate by a screen printing method in accordance with a third preferred embodiment of the present invention. The substrate 400 has an upper surface 401 and a lower surface 402. The third preferred method utilizes two fixed blocks 405 and a blade 404. An isolating material 403 is either coated on the upper surface 401 or the lower surface 402 or on both upper and lower surfaces of the substrate. The isolating material 403, such as liquid epoxy or polymer, is coated evenly by the blade 404 on the whole surface of the substrate. A curing process is performed once the isolating material 403 is coated onto the surfaces of the substrate to cure the isolating material 403.

FIG. 5 illustrates a schematic cross-sectional view of laminating metal foils onto a substrate 500. The substrate 500 has an upper surface 501 and a lower surface 502, wherein an isolating layer 503 is formed on the upper surface 501 and the lower surface 502. A circuit (not shown) can be patterned on the substrate 500 when the isolating material 503 is coated on the whole surface of the substrate 500. The isolating material 503 is filled into vias of the circuit (not shown), so the step of electrical filling of the vias can be omitted. A curing process is performed to cure the isolating material 503 on the substrate. Thus isolating layers 503 are formed on the surfaces of the substrate. Next, metal foils 504 are laminated onto the isolating layers 503. Heating and pressurization processes are performed to bond the metal foil 504 onto the isolating layers 503. The metal foil 504 comprises copper foil, for example.

The above-described embodiments are used as examples; thus, the methods of coating the isolating material of the present invention are not limited to the above-described embodiments. The isolating material is coated directly onto the surfaces of the substrate. The thickness of the isolating layers is controlled by the equipment parameters such as the rolling equipment, spraying equipment or the screen printing equipment. The metal foil is laminated onto the isolating layers of the upper surface and the lower surface of the substrate. Since the thickness of the isolating layers can be controlled easily by the equipment parameters, various types of metal foil can be used, such as high profile copper foil, low profile copper foil or reverse copper foil. The thickness of the isolating layer and the type of metal foil used can be varied according to the requirements of the circuit.

The advantages of the present invention are as follows:

1. The thickness of the isolating layer can be varied easily in accordance with the needs of the circuit design on the substrate. As a matter of fact, the thickness of the printed circuit board can affect the Radio frequency (RF) properties and the impedance of the circuit. As in the conventional method, the thickness of the printed circuit board is limited due to the type of coated metal foil used, which makes it difficult to reduce or increase the thickness of the printed circuit board. However, the isolating material of the present invention is coated directly onto the surfaces of the substrate; thus, the thickness of the isolating layers can be varied and controlled. An even and uniform isolating layer can be formed without difficulty.

2. With the increasing demand for highly-integrated circuits, the size of the PCB has been reduced while its reliability has been improved. Since the thickness of the isolating layer on the substrate of the present invention can be controlled easily, the thickness of the PCB can be reduced by reducing the thickness of the isolating layer, so that the impedance can be reduced and the RF signal transmission is improved.

3. The isolating materials that are utilized are those materials that have a good adhesive property and are low in cost; thus, the present invention is suitable to be utilized in mass production.

4. Isolating material is utilized to fill the vias, so no additional electrical filling process is required. Thus the fabrication process is simplified.

5. Since the whole process is performed in a line-production, the integration of the whole product can be improved.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A method of laminating copper foil onto a substrate of printed circuit board, the steps of the method comprising:
providing a substrate having an upper surface and a lower surface;
coating isolating material onto the upper surface and the lower surface of the substrate;
performing a curing process to allow the isolating material to form isolating layers on the upper surface and the lower surface of the substrate; and
laminating metal foils onto the isolating layers formed on the upper and lower surfaces of the substrate.

2. The method of claim 1, wherein the substrate is made of flame-retardant epoxy-glass fabric composite resin (FR-4, FR-5) or bismaleimide-triazine (BT).

3. The method of claim 1, wherein the isolating material comprises liquid epoxy resin.

4. The method of claim 1, wherein the isolating material comprises polymer.

5. The method of claim 1, wherein the isolating material comprises polyimide.

6. The method of claim 1, wherein a thickness of the isolating layers is controlled by equipment parameters regardless of the type of the metal foil that is used.

7. The method of claim 1, wherein the metal foil comprises copper foil.

8. The method of claim 7, wherein the types of the copper foil comprise high profile copper foil, low profile copper foil or reverse copper foil.

10. The method of claim 1, wherein the step of coating the isolating material further comprises a rolling method.

11. The method of claim 1, wherein the step of coating the isolating material further comprises a spraying method.

12. The method of claim 1, wherein the step of coating the isolating material further comprises a screen printing method.

13. The method of claim 1, wherein the step of laminating copper foil further comprises heating and pressurization processes to secure the metal foil onto the surfaces of the substrate.

14. A method of laminating copper foil onto a substrate of a printed circuit board, the steps of the method comprising:
providing a substrate having an upper surface and a lower surface;
coating isolating material onto the upper surface and the lower surface of the substrate;
performing a curing process to allow the isolating material to form isolating layers on the upper surface and the lower surface of the substrate;
laminating metal foils onto the upper surface and the lower surface of the substrate; and
performing heating and pressurization processes to secure the metal foils to the surfaces of the substrate.

15. The method of claim 14, wherein the substrate is made of flame-retardant epoxy-glass fabric composite resin (FR-4, FR-5) or bismaleismide-triazine (BT).

16. The method of claim 14, wherein the isolating material comprises liquid epoxy resin.

17. The method of claim 14, wherein the isolating material comprises polymer.

18. The method of claim 14, wherein the isolating material comprises polyimide.

19. The method of claim 14, wherein the metal foil comprises copper foil.

20. The method of claim 19, wherein the types of the copper foil comprise high profile copper foil, low profile copper foil or reverse copper foil.

21. The method of claim 14, wherein the thickness of the adhesive layers is controlled by equipment parameters regardless of the type of the metal foil that is used.

22. The method of claim 14, wherein the step of coating the isolating material further comprises a rolling method.

23. The method of claim 14, wherein the step of coating the isolating material further comprises a spraying method.

24. The method of claim 14, wherein the step of coating the isolating material further comprises a screen printing method.
